(19) United States
(12) Patent Application Publication
(10) Pub. No.: US 2011/0301853 A1
(43) Pub. Date: Dec. 8, 2011

(54) Tumor Discriminator

(76) Inventors: Ancha Baranova, Annandale, VA (US); Ganiraju Manyam, Vienna, VA (US); Alessandro Giuliani, Roma (IT)

(21) Appl. No.: 12/958,359

(22) Filed: Dec. 1, 2010

Related U.S. Application Data
(60) Provisional application No. 61/265,462, filed on Dec. 1, 2009.

(51) Int. Cl. G06F 19/00

(52) U.S. Cl. 702/19

(57) ABSTRACT

A tumor discriminator determines if a biological sample is diseaseous. Summarized expression value samples in a reference dataset are determined. The summarized expression value being a summation of gene expression levels for disease and normal samples. A biological sample summarized expression value is determined using a gene expression profile for a biological sample. A disease sample distance is estimated from the biological sample summarized expression value to a location in the disease sample space. The disease sample space defined by a statistical analysis of the disease samples. A normal sample distance is estimate from the biological sample summarized expression value to a location in the normal sample space The normal sample space defined by a statistical analysis of the normal samples. The disease sample distance is compared with the normal sample distance to determine if the biological sample is diseaseous.

### CROSS-REFERENCE TO RELATED APPLICATIONS

This application claims the benefit of U.S. Provisional Application No. 61/265,462, filed Dec. 1, 2009, entitled “Use of the Genome-Wide Expression Pattern as Composite Biomarkers of Cancer,” which is hereby incorporated by reference in its entirety.

### BRIEF DESCRIPTION OF THE SEVERAL VIEWS OF THE DRAWINGS

FIG. 1 depicts four parameters as panels of paired plots for the lobular and ductal breast carcinoma dataset.

FIG. 2 is a collection of example plots that show how distance parameters successfully separate samples as per an aspect of an embodiment of the present invention.

Example FIGS. 3A and 3B show linear graphs depicting the relative distance of samples to the Normal Sample Space as defined by DNGlobal and DNSpecific metrics in the multi-stage datasets as per an aspect of an embodiment of the present invention.

FIG. 3B illustrates the linear graphs of the DN metric for the multi-stage datasets as per an aspect of an embodiment of the present invention.

FIG. 4 illustrates the three-dimensional representation of principal components PC1, PC2 and PC3 in the two-point paired and population datasets as per an aspect of an embodiment of the present invention.

FIG. 5 shows two panels describing the topology of cell-kind and tumor attractors and a classical view of cancer.

FIG. 6 is a flow diagram of a method to determine if a biological sample is diseaseous as per an aspect of an embodiment of the present invention.

FIG. 7 shows the relationship of distances between a biological sample and normal and disease spaces as per an aspect of an embodiment of the present invention.

### DETAILED DESCRIPTION OF EMBODIMENTS

Embodiments of the present invention perform a quantitative estimation of the relative importance of global and local features of gene expression regulation landscape in the process of tumor development through an analysis of microarray data. In other words, embodiments of the present invention use aggregated gene expression signatures describing tumor and normal human tissues for discrimination of the malignant and normal tissues and for defining the degree of malignancy (how far advanced the tumor is), essentially predicting cancer disease state and prognosis, without the need for specific biomarkers.

First, after initial sets of normal and tumors samples for particular cancers are analyzed to define Normal and Cancer Spaces, the classification of new samples to be diagnosed may be achieved by the calculation of sample specific distance from the sample to a Normal Space (DN) and to a Cancer Sample (DC). If DN>DC, the sample may be classified as cancer. If DC>DN, the sample may be classified as normal. An increase in the number of the initially profiled samples may provide for better definition of the Normal and Cancer Spaces and better classification of the subsequent samples.

Second, for every sample to be diagnosed, the distance from the sample to the Normal Space may be plotted linearly, and the degree of the malignancy of the given sample may be proportional to the linear distance. Therefore, the relative degree of the malignancy may be assigned to the sample using whole-genome patterns of the gene expression, without the need for specific biomarkers or gene signatures.

Third, the principal component analysis (PCA) on the four-dimensional space spanned by four indexes (DCglobal, DNglobal, DCspecific, DNspecific) may be used for sample discrimination. The term “global” refers to the larger data set and the term “specific” refers to a specific sample being analyzed. Each new sample to be diagnosed may be added to the reference dataset of the cancer and normal tissues of the particular cell-type. PCA may be executed on the whole dataset. The first three components (PC1, PC2, PC3) may be used for three-dimensional graphing of the results. New samples may be co-classified with the group of the samples with similar degree of the malignancy. This approach may also be used for multi-component datasets comprised of normal samples and more than one set of tumors with different degrees of malignancy.

To date, most of the high-throughput studies of the gene expression studies were focused on elucidation of the gene signatures discriminating cell phenotypes. On the other hand, a given cell type could be represented as a dynamic system occupying a specific position in the multidimensional phase space spanned by all expressed genes. In terms of dynamics, this specific position is called an ‘attractor’, i.e. a ‘stable” position characterized by a specific pattern of gene expression levels that determines the particular type of the cell differentiation. Some studies have indicated that the differentiation destinies of the progenitor cells could be defined as high dimensional attractor states of the underlying molecular networks. A possible middle ground between discriminating signatures and entire expression landscapes may be described as a combination of attractor-like behavior with some local ‘vantage points’ represented by genes most sensitive to dynamical changes of the system.

Tests were performed according to embodiments of the present invention. Affymetrix Microarray datasets were extracted from the NCBI Gene Expression Omnibus. Two categories of datasets were analyzed: A) datasets describing paired normal and tumor tissue samples collected from the same individual; and B) datasets describing a group of normal and a group of tumor samples collected from the same tissue type across a number of subjects. Global and specific expression distances (Dglobal and Dspecific) were calculated based on the whole transcripts on the chip and significantly differentially expressing transcripts by Mann-Whitney test, respectively. The distances between expression profiles of two biological samples were estimated using Pearson correlation coefficients. In all studied datasets, on average, tumors were further away from the Normal Sample Space than the paired samples with normal histology. Interestingly, this observation was true only in case when distances were calculated using Dglobal. Surprisingly, similarly calculated distances for Normal samples from the Normal Space defined by Dspecific were different not significantly, mostly due to larger variations in the expression of cancer-specific genes in the normal samples. In all datasets, mean (Dglobal) distances from individual normal samples to the Normal Space were correlated with Mean (Dglobal) distances from individual tumor samples (R=0.9236, p<=0.00186). Principal Component Analysis (PCA), for the first time, a quantitative estimation of the relative importance of global and local features of gene expression regulation landscape in the process of tumor development. The behavioral invariance observed in eighteen independent tumor data sets gives a robust proof of the dynamical picture of cell populations.

To date, most of the high-throughput studies of the gene expression studies are focused on elucidation of the discriminatory gene signatures reflecting key regulatory processes participating in establishing cell phenotypes. On the other hand, a change in a cell phenotype requires coordinated interaction of a variety of genes that determine the functional identity of the cell within a population of cells. This notion implies an understanding that a given cell type could be represented as a dynamic system that can assume different states, thus, occupying a specific position in the multidimensional phase space spanned by the different genes.

In terms of dynamics, this specific position of equilibrium is called an ‘attractor’, i.e. a “stable” position characterized by a specific pattern of gene expression levels that determines the particular kind (differentiation pattern) of the cell population. Multiple attractor states may exist. The current stable state of the cells may depend on the history of the past states of cell, implicating the importance of epigenetic mechanisms in such a context. The attractor states are robust, distinct and possess self stabilizing properties. The gene expression pattern associated with a particular state may be maintained even after the original stimulus that placed the cell in the current attractor state has been removed. Of course, the attractor state is a property of the cell population, so its location in the phase space may correspond to the average expression levels for the millions of single cells over thousands of genes. When individual gene expression levels are measured, cells could be different for each other, thus, demonstrating intra-population variance. In this sense, attractor state may be viewed as an analogy to the definition of the temperature in statistical mechanics that allows for evaluation of the intrinsic differences between the components of the system.

Earlier studies have indicated that the differentiation destinies of the progenitor cells could be defined as high dimensional attractor states of the underlying molecular networks. Particularly, a study of the differentiation trajectories of blood stem cells demonstrated that specific differentiated cell types behave as attractors. The same group provided some evidences of an analogous behavior of the cancer cells that are to be considered as located at the ‘periphery’ of the correspondent normal cell attractor for the same kind of tissue. Although cancer was proposed as an attractor state of a cell as early as 1971, a path to verify such a notion has been paved only recently, with an advent of the genomic technologies.

Under “attractor” paradigm, cell population may be considered as a dynamic system that could be attracted to one or another “stable” state by transition that implies extensive mutual regulation of all elements of cell's genome. This is in striking contrast with the traditional idea of a division of the mRNA transcripts into those generated by ‘housekeeping’ and ‘tissue-specific genes’, where a set of the master genes may be responsible for the switch between different phenotypes. ‘Democratic’ genes may refer to genes where the there are no master genes (i.e. all genes act as mutual regulators going toward a global attractor state). ‘Autocratic’ genes are where a few master genes drive the differentiation process and regulatory landscape.

A possible middle ground between “democratic” and ‘autocratic” regulatory landscapes may be described as a general attractor-like behavior of the regulatory machinery with some local ‘vantage points’ representing genes most sensitive to dynamical changes of the system. A recent study demonstrated biphasic nature of the cellular response to innate immune stimuli involving an acute-stochastic mode consisting of small number of sharply induced genes and a collective mode where a large number of weakly induced genes adjust their expression levels to novel “stable” state. Embodiments of the present invention take advantage of a similar regulatory scenario that takes place during tumor development.

Specifically, embodiments of the present invention treat cancer as an attractor state. Normal cell may became cancerous and progress toward malignant phenotype using an intermediate regulatory framework that combines both local and global regulatory features. Embodiments of the present invention perform a quantitative estimation of the relative importance of global and local features of gene expression regulation landscape in the process of tumor development through an analysis of microarray data.

Materials and Methods

Microarray datasets were extracted from the NCBI Gene Expression Omnibus as raw data (.CEL files) by selecting the data using Oncomine browser. To exclude cross-platform variability factors, only the datasets profiled using Affymetrix oligonucleotide arrays were chosen. The chosen datasets were classified into the following three categories: 1) Two-point datasets describing paired normal and tumor tissue samples collected from the same individual (N=8); 2) Two-point datasets describing a group of normal and a group of tumor samples collected from the same tissue type across a number of subjects (N=9); 3) Multi-point datasets describing three or more physiological groups of normal and tumor samples collected from same subject or across a number of subjects (N=7). The detailed descriptions of these datasets are given in the tables 1, 2 and 3 for each of categories, respectively.

Example Table 1 describes the attributes of two-point datasets describing paired normal and tumor tissue samples collected from the same individual.

TABLE 1

| | | | Total Number |
|---|---|---|---|
| | | | of transcripts |
| | | | extracted; |
| | | | Total number |
| | | | of transcripts |
| | | Number of | significant by |
| GEO ID | Sample source | samples | MW test |
| GSE5764 | Invasive ductal | IDC (N = 5) | 54675; 2278 |
| | (IDC) and lobular | Normal | |
| | breast (ILC) | ductal (N = 5) | |
| | carcinomas in | ILC (N = 5) | 54675; 988 |
| | postmenopausal | Normal | |
| | patients | lobular (N = 5) | |
| GSE2514 | Pulmonary | Lung AdCa | 12625; 5857 |
| | adenocarcinoma and | (N = 20) | |
| | adjacent lung tissue | Normal (N = 19) | |
| GSE7670 | pulmonary | Lung AdCa | 22283; 8599 |
| | adenocarcinoma and | (N = 27) | |
| | adjacent lung tissue | Normal (N = 27) | |
| GSE6344 | Renal cell carcinoma | Stage 1 | 44760; 23701 |
| | (RCC) | tumor (N = 5) | |
| | | Stage 2 | |
| | | tumor (N = 5) | |
| | | Stage 1 | |
| | | normal (N = 5) | |
| | | Stage 2 | |
| | | normal (N = 5) | |
| GSE781 | Renal clear cell | Tumor (N = 7) | 44760; 11119 |
| | carcinoma (RCC) | Normal (N = 7) | |
| GSE6631 | Head and neck | Tumor (N = 22) | 12625; 2880 |
| | squamous cell | Normal (N = 22) | |
| | carcinoma (HNSCC) | | |
| GDS1665 | papillary thyroid | Tumor (N = 9) | 54675; 13985 |
| | carcinoma (PTC) | Normal (N = 9) | |

Analysis was performed by R data analysis packages of Bioconductor. Affy package was used for the data processing and normalization. Perl scripting has been used to automate the analysis pipeline. The gene expression data were background corrected, normalized and the summarized expression values were calculated using Robust Multichip Average (RMA) method that consists of three steps: a background adjustment, quantile normalization and, finally, summarization. The expression values for individual genes in each of the cancer and normal samples were subjected to non-parametric Mann-Whitney test that extracted the transcripts with significant (P<0.05) differential expression. The global and specific expression distances (DGlobal and DSpecific) were calculated based on the whole transcripts on the chip and significantly differentially expressing transcripts as selected by Mann-Whitney test, respectively. The distance between two samples i and j corresponds to: Dij=1−Rij, where Rij is the Pearson correlation coefficient between the vectors correspondent to i and j samples and having as dimensions the entire set of transcripts (DGlobal) or only the gene with statistically significant expression differences (DSpecific).

Principal Component Analysis (PCA) was performed on the cancer microarray expression datasets based on the distance parameters. In this example analysis, each sample is described by four distance based descriptors reflecting the average distance of each sample from i) cancer sample space (DC) and ii) normal sample space (DN) in both global and specific frames, therefore, producing following variables: DCGlobal, DNGlobal, DCSpecific and DNSpecific. PCA was performed using R on each of the datasets separately, in the four dimensional space represented by these parameters.

Example Table 2 describes the two-point datasets comprised of normal and tumor samples collected from the same tissue type across a number of subjects.

TABLE 2

| | | | Total Number |
|---|---|---|---|
| | | | of transcripts |
| | | | extracted; |
| | | | Total number |
| | | | of transcripts |
| | | Number of | significant by |
| GEO ID | Sample source | samples | MW test |
| GSE6791 | Gene Expression | Normal | 54675; 35778 |
| | Profiles of HPV- | Head/Neck (N = 14) | |
| | Positive and - | Head/Neck | |
| | Negative Head/Neck | Cancer (N = 42) | |
| | Cancers | | 54675; 25098 |
| | Gene Expression | Normal | |
| | Profiles of HPV- | Cervix (N = 8) | |
| | Positive and - | Cervical | |
| | Negative Cervical | Cancer (N = 20) | |
| | Cancers | | |
| GSE3678 | Papillary thyroid | Normal | 54675; 5617 |
| | carcinoma | Thyroid (N = 7) | |
| | | Papillary | |
| | | thyroid | |
| | | carcinoma (N = 7) | |
| GSE3524 | Oral squamous cell | OSCC (N = 16) | 22283; 5757 |
| | carcinoma (OSCC) | Normal (N = 4) | |
| GSE10797 | Transcriptomes of | Normal breast | 22277; 2491 |
| | breast epithelium | epithelium (N = 5) | |
| | and stroma in | Invasive | |
| | normal reduction | breast cancer | |
| | mammoplasty and | epithelium (N = 28) | |
| | invasive breast | Normal breast | 22277; 1190 |
| | cancer patients. | stroma (N = 5) | |
| | | Invasive | |
| | | breast cancer | |
| | | stroma (N = 28) | |
| GSE12345 | Global gene | Normal pleural | 54675; 5995 |
| | expression profiling | tissue (N = 8) | |
| | of human pleural | Mesothelioma | |
| | mesotheliomas | tissue (N = 8) | |
| GSE12452 | mRNA expression | Normal | 54675; 15383 |
| | profiling of | nasopharyngeal | |
| | nasopharyngeal | tissue (N = 10) | |
| | carcinoma | nasopharyngeal | |
| | | carcinoma (N = 31) | |
| GSE14762 | Renal Cell | Normal renal | 54675; 18501 |
| | Carcinoma: Hypoxia | tissue (N = 12) | |
| | and Endocytosis | Renal | |
| | | carcinoma (N = 10) | |

Example Table 3 describes the datasets with three or more physiological groups of normal and tumor samples collected across the same subject or a number of subjects.

TABLE 3

| | | | Total Number |
|---|---|---|---|
| | | | of transcripts |
| | | | extracted; |
| | | | Total number |
| | | | of transcripts |
| | | Number of | significant by |
| GEO ID | Sample source | samples | MW test |
| GSE1420 | Barrett's | Normal (N = 8) | 22283; 6552 |
| | esophagus, | Barrett' | |
| | Barrett's- | esophagus | |
| | associated | (N = 8) | |
| | adeno- | Barrett's- | |
| | carcinomas | associated | |
| | and normal | adenocarcinoma | |
| | esophageal | (N = 8) | |
| | epithelium | | |
| GSE3325 | Benign | Benign | 54675; 20667 |
| | prostate, | prostate (N = 6) | |
| | primary and | primary prostate | |
| | metastatic | cancer (N = 7) | |
| | prostate | metastatic | |
| | cancer | prostate (N = 6) | |
| | samples | | |
| http://dot. | Normal | Normal | 7129; 2289 |
| ped.med. | pancreas, | pancreas (N = 5) | |
| umich.ed | chronic | Chronic | |
| u:2000/p | pancreatitis | pancreatitis | |
| ub/Panc_{—} | and pancreatic | (N = 5) | |
| tumor/ind | adeno- | Pancreatic | |
| ex.html | carcinoma | adeno- | |
| | (micro- | carcinomas | |
| | dissected) | (n = 10) | |
| GSE3167 | Normal Bladder, | Normal | 22283; 13861 |
| | superficial | Bladder (N = 9) | |
| | transitional | sTCC (N = 15) | |
| | cell | sTCC with | |
| | carcinoma | CIS (N = 13) | |
| | (sTCC), STCC | mTCC (N = 13) | |
| | with carcinoma | Cystectomy | |
| | in situ, | Normal(N = 5) | |
| | metastatic | CIS (N = 5) | |
| | transitional | | |
| | cell carcinoma, | | |
| | normal | | |
| | cystectomy and | | |
| | cystectomy | | |
| | with CIS | | |
| GSE6919 | The Normal | Normal Prostate | 37757; 18973 |
| | Prostate Tissue | Tissue free of | |
| | free of any | any pathological | |
| | pathological | alteration | |
| | alteration., | (N = 17) | |
| | Metastatic | Metastatic | |
| | Prostate | Prostate(N = 25) | |
| | Tumor, Primary | Primary | |
| | Prostate Tumor, | Prostate (P = 59) | |
| | Normal Prostate | Normal Prostate | |
| | Tissue Adjacent | Tissue Adj to | |
| | to Tumor | Tumor (N = 62) | |
| GSE6764 | Genome-wide | Normal | 54675; 19250 |
| | molecular | liver (N = 10) | |
| | profiles of | Dysplastic liver | |
| | HCV-induced | tissue (N = 17) | |
| | dysplasia and | Cirrhotic liver | |
| | hepatocellular | tissue (N = 13) | |
| | carcinoma | Very early | |
| | | HCC (N = 8) | |
| | | Early | |
| | | HCC (N = 10) | |
| | | Advanced | |
| | | HCC (N = 7) | |
| | | Very Adv | |
| | | HCC (N = 10) | |
| GSE10971 | Gene expression | Normal | 54675; 15988 |
| | data from non- | controls (N = 12) | |
| | malignant | BRCA-1/2 | |
| | fallopian tube | mutation | |
| | epithelium | carriers | |
| | and high | (N = 12) | |
| | grade serous | High grade | |
| | carcinoma. | serous | |
| | | carcinoma | |
| | | (N = 13) | |

The structure of correlations emerging from the analysis of the variable loadings on the extracted components allowed for a straightforward quantification of some relevant topological features of the analyzed systems.

Results and Discussion

a) Modeling Strategy

In some embodiments, the discrimination between a tumor and a normal sample may be achieved using both a summed expression change involving the entire set of mRNAs (DGlobal) and a summed expression change of the functionally important genes specifically involved in the development of the tumor state (DSpecific). In the case of the “democratic” regulatory landscape (no preferred vantage points, or particular mRNAs, specifically responding to the change of the physiological state), the discrimination may be achieved by DGlobal, while gene signature-based (DSpecific) distances may better reflect “autocratic” landscape with a profound changes in expression of master (or signature) genes while the great portion of mRNAs remain unaffected. In the latter case, the correlation between genome-wide (DGlobal) and signature-based (DSpecific) distances should not be substantial.

In case of an intermediate scenario,—a middle ground between “democratic” and “autocratic” regulatory landscapes,—the discrimination between tumor and normal sample calculated using DSpecific should be consistently better than the discrimination achieved using by DGlobal. However the two metrics should correlate, thus, demonstrating both the existence of a global attractor correspondent to the cell phenotype and reflecting the change of entire genome expression and the most influential roles for a specific set of the tumorigenesis-related genes.

The most natural metrics for estimating the distance between expression profiles of two biological samples is based on the Pearson correlation coefficient: the level of concordance of any two expression vectors correspondent to two different biological samples, x and y with n dimension (n=genes) and mean values of expressions x̅ and y̅corresponds to their mutual Pearson correlation, r=(x,y) defined as:

$$\begin{matrix}r ( x , y ) = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}} \\ = \frac{{\sum }_{i = 1}^{n} {X}_{i} {Y}_{i}}{\sqrt{{\sum }_{i = 1}^{n} {X}_{i}^{2}} \sqrt{{\sum }_{i = 1}^{n} {Y}_{i}^{2}}} \\ = \frac{X \cdot Y}{\vert X \vert \vert Y \vert} \\ = cos θ ,\end{matrix} \qquad Eq . 1$$

where X=(x₁− x̅, x₂− x̅, . . . , xₙ− x̅), Y=(y₁− y̅, y₂− y̅, . . . , yₙ− y̅) corresponding to the differences from the mean expression of each gene in the X and Y sample respectively and θ is the angle between two expression vectors. Geometrically, Eq. 1 shows the correlation coefficient may be viewed as the cosine of the angle on n-dimensional space between the two vectors of data that have been shifted by the average to have mean zero. Angle θ is a measure of the differences between the two vectors and consequently of the difference in expression pattern of the two sample, when θ=0 (and consequently r=1.0) the two expression patterns are completely coincident, and the two vectors are parallel. In the case of r=1 (and consequently θ=90 degrees) the two expression vectors are orthogonal, i.e. the expression patterns of the two samples are each other independent.

The measure Dij=1−Rij with R=Pearson correlation coefficient between i and j samples can be considered as a distance between samples. This distance could vary from 0 (R=1) reflecting the perfect resemblance of the two samples to 1 corresponding to maximal possible distance between two states (absence of correlation). In the case when samples are picked from two different sub-groups—normal (N) and cancer (C)—for each sample j analyzed two different descriptors DCj and DNj can be computed corresponding to the average distance of sample j from the spaces occupied by cancer (DCj) and normal (DNj) samples. Thus if (i) corresponds to a cancer sample DCi will be the average of all the pairwise distances of (i) vector from all the other cancer samples vectors, and consequently DNi the average of all the distances of (i) from the non-cancer samples. When the distance is computed only over the previously extracted differentiating gene signature defined as a set of genes with expression values significantly different between Cancer and normal subgroups by Mann-Whitney test, two similarly defined but gene signature-specific distance indexes (DCSpecific, DNSpecific) were obtained. In some embodiments, four descriptors may be defined for specific samples on each dataset:

DCGlobal: Genome-wide distance from cancer sample space to the particular sample

DNGlobal: Genome-wide distance from normal sample space to the particular sample

DCSpecific: Signature based distance from cancer sample space to the particular sample

DNSpecific: Signature based distance from normal sample space to the particular sample

b) Assessment of the Global and Signature-Specific Gene Expression Distances for Two-Point (Normal-Tumor) Datasets.

In an example study, a total of 17 two-point datasets represented by normal and tumor gene expression profiles. Paired datasets (tumor and normal samples derived form the same individual) and populational datasets (tumor and normal samples were collected across a number of subjects) were considered separately. Eight paired and nine population datasets profiled using the Affymetrix platforms were chosen for the two-point (normal-tumor) analysis (Tables 1, 2). For each dataset, the global and specific expression distances were calculated based either on the all probes present on the chip and passing the detection call (DNGlobal and DCGlobal) or on the genes highlighted as significantly differentially expressed according to Mann-Whitney test (DNSpecific and DCSpecific).

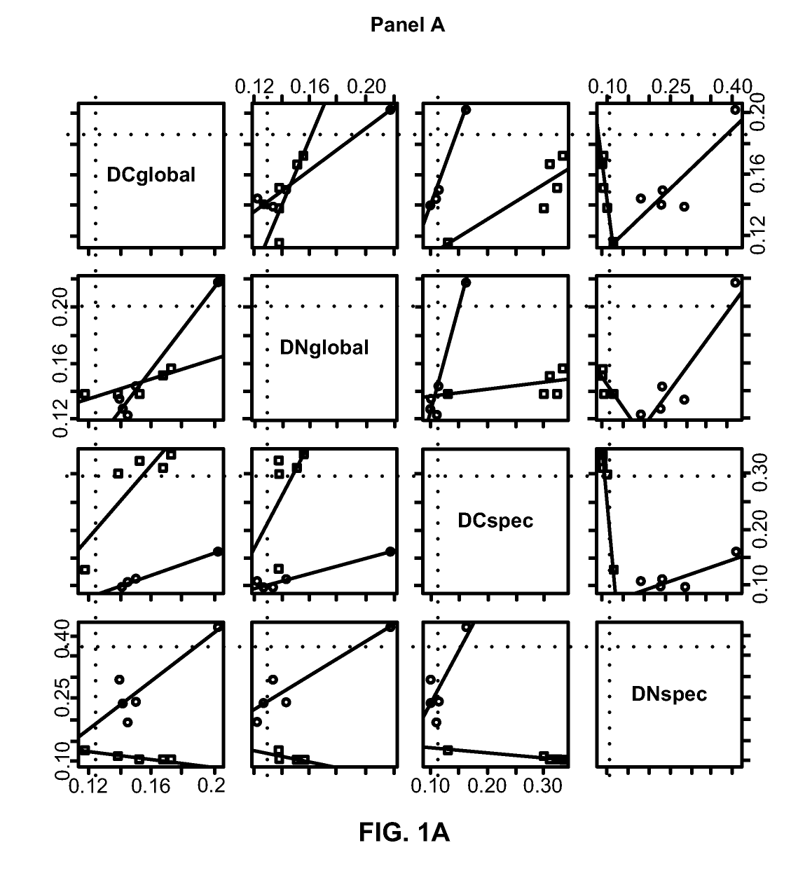

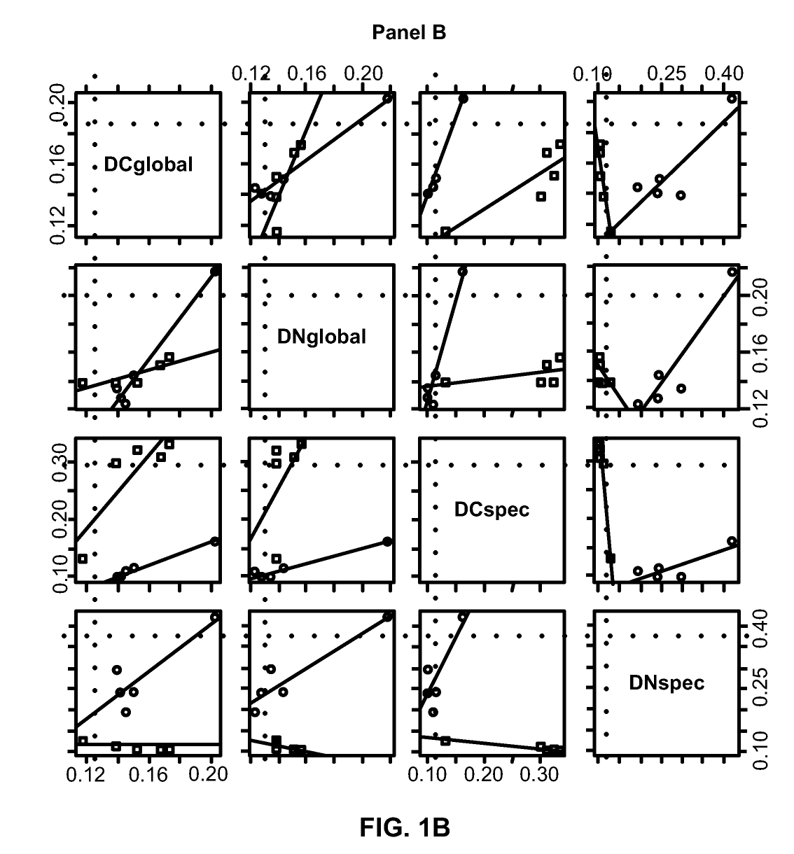

In both paired and population datasets, DC (global, specific) was greater than DN (global, specific) for most of the normal samples. The reverse was true, i.e. DC (global, specific) is less than DN (global, specific) for the tumor samples. Such a relation provides a basis an unbiased classification scheme, given a sufficiently relevant population of samples is achieved. FIG. 1 depicts the four parameters as panels of paired plots for the lobular and ductal breast carcinoma dataset. The clear classification of the cancer and tumor samples using the complete chip data (global expression patterns) using a simple metrics (e.g. the distance) illustrate the differentiating power of the overall transcription. Moreover, ranking of the datasets based on global and specific distances of the tumor sample from the normal center were very similar, albeit not identical (Table 4). The conservation of global and specific distances across the datasets adds to the credibility of using this metric for diagnostic purpose.

Example Table 4 shows rankings of the tumor malignancy potential according to the relative distance to the Normal Sample Space (two-point paired datasets) 1—lowest; 9—highest.

TABLE 4

| | Mean (DGlobal) | Mean (DSpecific) |
|---|---|---|
| | from individual | from individual |
| | tumor samples to | tumor samples to |
| DATASET | the Norma center | the Normal center |
| GSE2514 (pulmonary | 1 | 1 |
| adenocarcinoma) | | |
| GDS1665 (papillary thyroid | 2 | 2 |
| carcinoma) | | |
| GSE781 (RCC) | 3 | 4 |
| GSE6344 (RCC stage 2) | 5 | 3 |
| GDS2520 (HNSCC) | 4 | 6 |
| GSE6344 (RCC stage 1) | 6 | 5 |
| GSE7670 (pulmonary | 7 | 7 |
| adenocarcinoma) | | |
| GSE5764 (ductal breast | 8 | 8 |
| cancer subset) | | |
| GSE5764 (lobular breast | 9 | 9 |
| cancer subset) | | |

In case when distances were calculated using DNGlobal, in studied paired data, tumors were further away from the Normal Sample Space than the control samples with normal histology (Table 5). On average, for normal samples the distance to the Normal Space defined by DGlobal was 0.047+/−0.045 as compared to 0.080+/−0.034 for Tumor samples (P<0.038) in paired datasets. Distances between individual Normal samples and the Normal Space defined by DSpecific were also significantly different from that calculated for Tumor samples (Normal: 0.044+/−0.034; Tumor: 0.138+/−0.063, P<0.001). Metrics were heavily correlated to each other. This correlation indicates strong attractor-like behavior; the discussion on this would be continued in the PCA results section. Here it is important to stress that signature-based and genome-wide approaches allow for the same level of discrimination efficiency of the data sets.

Example Table 5 shows Mean, Standard Deviation and Variance calculated for Global and Specific Distances from individual samples to the Normal Sample Space of the paired datasets.

TABLE 5

| | Mean +/− SD | Mean +/− SD | Mean +/− SD | Mean +/− SD |
|---|---|---|---|---|
| | variance | variance | variance | variance |
| | (DNGlobal) | (DNGlobal) | (DNSpecific) | (DNSpecific) |
| | from individual | from individual | from individual | from individual |
| | normal samples | tumor samples | normal samples | tumor samples |
| | to the Normal | to the Normal | to the Normal | to the Normal |
| DATASET | Sample Space | Sample Space | Sample Space | Sample Space |
| GSE5764 | 0.0989 +/− 0.0111 | 0.1134 +/− 0.0196 | 0.0634 +/− 0.00595 | 0.1827 +/− 0.02951 |
| (ductal breast | 0.0001231 | 0.0003861 | 0.00003547 | 0.000870855 |
| cancer subset) | | | | |
| GSE5764 | 0.1449 +/− 0.0084 | 0.1496 +/− 0.0389 | 0.1092 +/− 0.01037 | 0.2788 +/− 0.0873 |
| (lobular breast | 0.0000704 | 0.00151395 | 0.00010758 | 0.00762137 |
| cancer subset) | | | | |
| GSE2514 | 0.0113 +/− 0.0015 | 0.0407 +/− 0.0199 | 0.0138 +/− 0.00211 | 0.0688 +/− 0.03296 |
| (pulmonary | 0.0000023 | 0.000399112 | 0.0000044 | 0.001086227 |
| adenocarcinoma) | | | | |
| GSE7670 | 0.0399 +/− 0.0104 | 0.0841 +/− 0.0285 | 0.0483 +/− 0.01129 | 0.1417 +/− 0.04826 |
| (pulmonary | 0.000107128 | 0.000814786 | 0.000127647 | 0.002329823 |
| adenocarcinoma) | | | | |
| GSE781 | 0.0187 +/− 0.008 | 0.0624 +/− 0.0087 | 0.0234 +/− 0.0128 | 0.1247 +/− 0.01585 |
| (RCC) | 0.0000646 | 0.0000751 | 0.0001639 | 0.0002513 |
| GDS2520 | 0.0577 +/− 0.0151 | 0.0742 +/− 0.0141 | 0.0789 +/− 0.01866 | 0.1362 +/− 0.02979 |
| (HNSCC) | 0.000227314 | 0.000197704 | 0.000348429 | 0.000887682 |
| GDS1665 | 0.0184 +/− 0.002 | 0.0407 +/− 0.0133 | 0.0168 +/− 0.002107 | 0.0785 +/− 0.0276 |
| (papillary | 0.0000039 | 0.0001773 | 0.0000044 | 0.0007636 |
| thyroid | | | | |
| carcinoma) | | | | |
| GSE6344 | 0.0216 +/− 0.0019 | 0.0802 +/− 0.0058 | 0.0219 +/− 0.00208 | 0.1213 +/− 0.00702 |
| (RCC stage 1) | 0.0000038 | 0.0000337 | 0.0000043 | 0.0000494 |
| GSE6344 | 0.0196 +/− 0.0022 | 0.0758 +/− 0.0096 | 0.0201 +/− 0.00265 | 0.1098 +/− 0.01424 |
| (RCC stage 2) | 0.0000048 | 0.0000926 | 0.0000070 | 0.0002028 |

Similar to that in paired datasets, by DNGlobal, tumors in the population datasets were further away from the Normal Sample Space than the control samples with normal histology (Table 6). On average, for normal samples the distance to the Normal Space defined by DGlobal was 0.0520+/−0.021 as compared to 0.095+/−0.032 for Tumor samples (P<0.012). Distances between individual Normal samples and the Normal Space defined by DSpecific were also significantly smaller than that that calculated for Tumor samples (Normal: 0.054+/−0.018; Tumor: 0.154+/−0.029, P<0.00078). The concordance between the populational and paired data sets allows us to exclude the hypothesis the ‘between distances’ correlation is driven by ‘individuality effects’, i.e. by the fact each single individual has a specific gene expression pattern accounting for the observed global/specific distance from tumor/distance from normal concordance.

C) Assessment of the Global and Signature-Specific Gene Expression Distances of Multi-Stage (Three or More Stage) Datasets

There were a total of 7 datasets describing tumor and normal samples collected from the same subject (1 dataset) or across a number of subjects (6 datasets). The development of the tumor usually involves its progression from the relatively benign to invasive and to metastatically aggressive phenotypes. It is widely accepted that the gene expression signatures are able to discriminate between distinct stages of the tumor development. To explore the idea whether a summed expression change involving the entire set of mRNAs behaves similarly to the changes in signature-specific, “master” genes, we calculated DNGlobal and DNSpecific for 7 datasets representing normal and tumor samples that were comprised of three or more distinct physiological states of the underlying tissue (six datasets from NCBI GEO and one external).

Example Table 6 shows Mean, Standard Deviation and Variance calculated for Global and Specific distances from individual samples to the Normal Sample Space in the populational datasets.

TABLE 6

| | DNGlobal | | DNSpecific | |
|---|---|---|---|---|
| | From individual | From individual | From individual | From individual |
| | normal samples | tumor samples | normal samples | tumor samples |
| | to the Normal | to the Normal | to the Normal | to the Normal |
| | Sample Space | Sample Space | Sample Space | Sample Space |
| | (Mean +/− SD; | (Mean +/− SD; | (Mean +/− SD; | (Mean +/− SD; |
| DATASET | variance) | variance) | variance) | variance) |
| GSE6791 | 0.05721 +/− 0.01671; | 0.13059 +/− 0.02493; | 0.064005 +/− 0.01937; | 0.1585726 +/− 0.03052591; |
| (cervical | 0.000279167 | 0.0006216929 | 0.000375219 | 0.000931831 |
| cancer) | | | | |
| GSE10797 | 0.08878211 +/− 0.018546943; | 0.1480193 +/− 0.04274649; | 0.0475659 +/− 0.009414584; | 0.1545566 +/− 0.03623782; |
| (invasive | 0.0003439891 | 0.0018272624 | 0.0000886343 | 0.0013131799 |
| breast | | | | |
| cancer) | | | | |
| GSE12345 | 0.06323201 +/− 0.01296917; | 0.0871369 +/− 0.02157966; | 0.0789417 +/− 0.01844578; | 0.1960226 +/− 0.05226790; |
| (pleural | 0.0001681993 | 0.0004656815 | 0.0003402469 | 0.0027319334 |
| mesothelioma) | | | | |
| GSE12452 | 0.05510947 +/− 0.01769130; | 0.077843 +/− 0.013091253; | 0.0707538 +/− 0.01992132; | 0.1413587 +/− 0.027503111; |
| (nasopharyngeal | 0.0003129822 | 0.0001713809 | 0.0003968591 | 0.0007564211 |
| carcinoma) | | | | |
| GSE14762 | 0.02229638 +/− 0.004879693; | 0.1080666 +/− 0.09848668; | 0.0302542 +/− 0.007646735; | 0.1875954 +/− 0.09617942; |
| (RCC) | 0.0000238114 | 0.009699626 | 0.0000584726 | 0.009250482 |
| GSE6791 | 0.05799383 +/− 0.01747614; | 0.0834743 +/− 0.01661218; | 0.0641543 +/− 0.01976013; | 0.1060674 +/− 0.02143241; |
| (HNSCC) | 0.0003054155 | 0.0002759646 | 0.0003904628 | 0.0004593481 |
| GSE3678 | 0.04147274 +/− 0.006705467; | 0.0560819 +/− 0.005507370; | 0.0493836 +/− 0.009431665; | 0.1582217 +/− 0.009836067; |
| (papillary | 0.00004496329 | 0.0000303311 | 0.0000889563 | 0.0000967482 |
| thyroid | | | | |
| carcinoma) | | | | |
| GSE3524 | 0.02964479 +/− 0.006389468; | 0.0715533 +/− 0.01914830; | 0.0298668 +/− 0.005858421; | 0.1318646 +/− 0.03691830; |
| (oral | 0.0000408253 | 0.0003666572 | 0.0000343211 | 0.0013629609 |
| squamous | | | | |
| cell | | | | |
| carcinoma) | | | | |

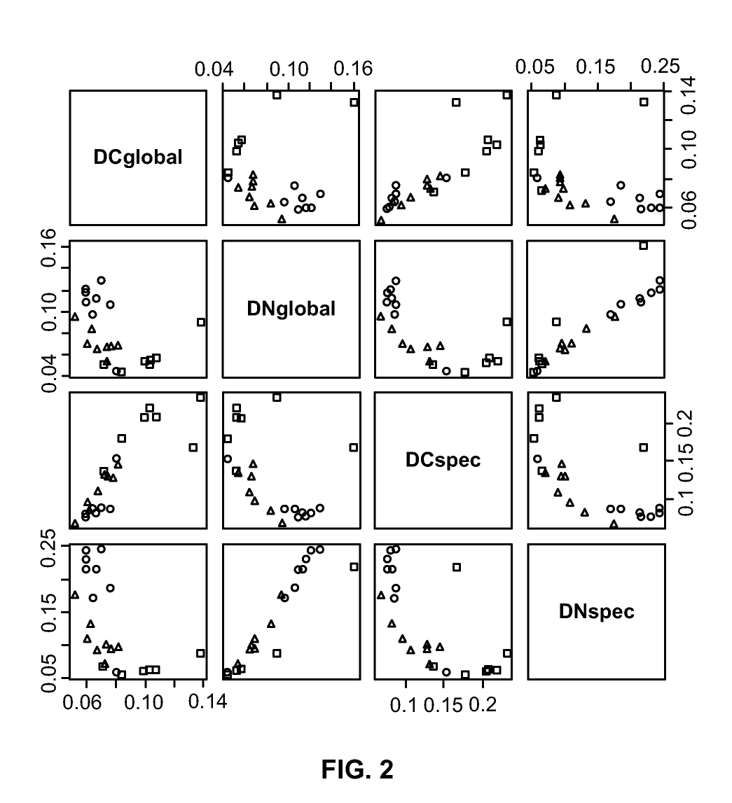

As GEO database contains only one dataset, GSE1420 (FIG. 2), that is represented by paired tissue samples profiled using Affimetrix platform, we added to this study 6 datasets comprised of the samples collected across a number of individuals and profiled using the same microarray platform (Table 3). For each dataset, the global and specific expression distances were calculated as described above. In all datasets, the progression of the disease was reflected in an increase of the distance of individual tumors from Normal Sample Space.

FIG. 2 is a collection of example plots that show how distance parameters successfully separate samples in the esophageal sample (GSE1420) dataset representing normal esophagus (blue), Barrett's esophagus (orange) and esophagus carcinoma (red) samples

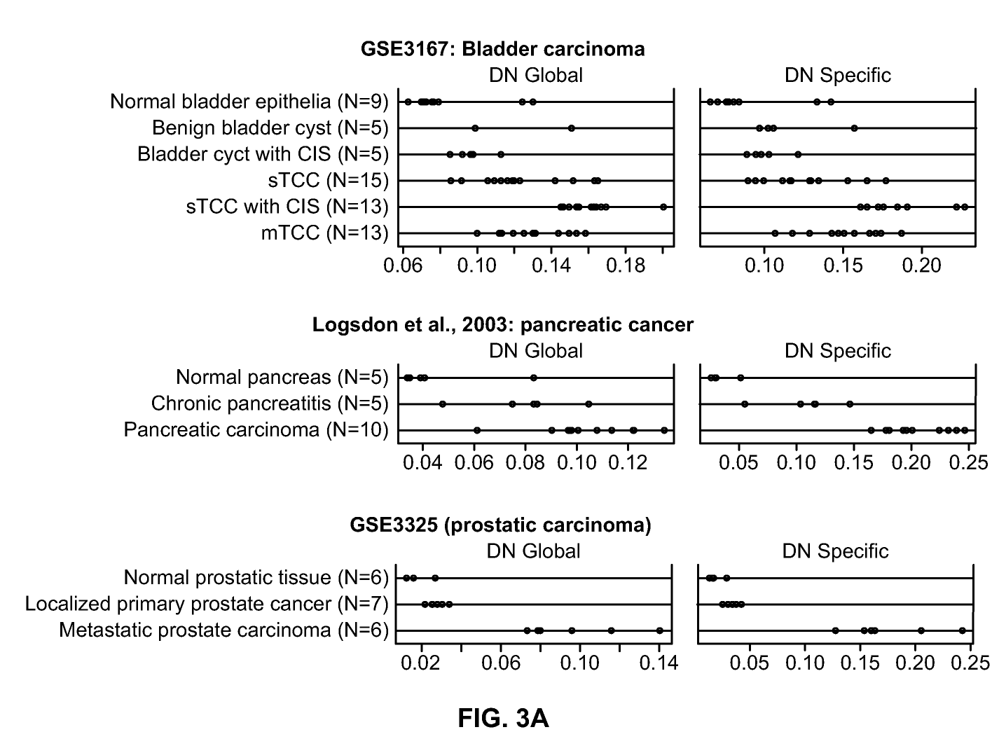

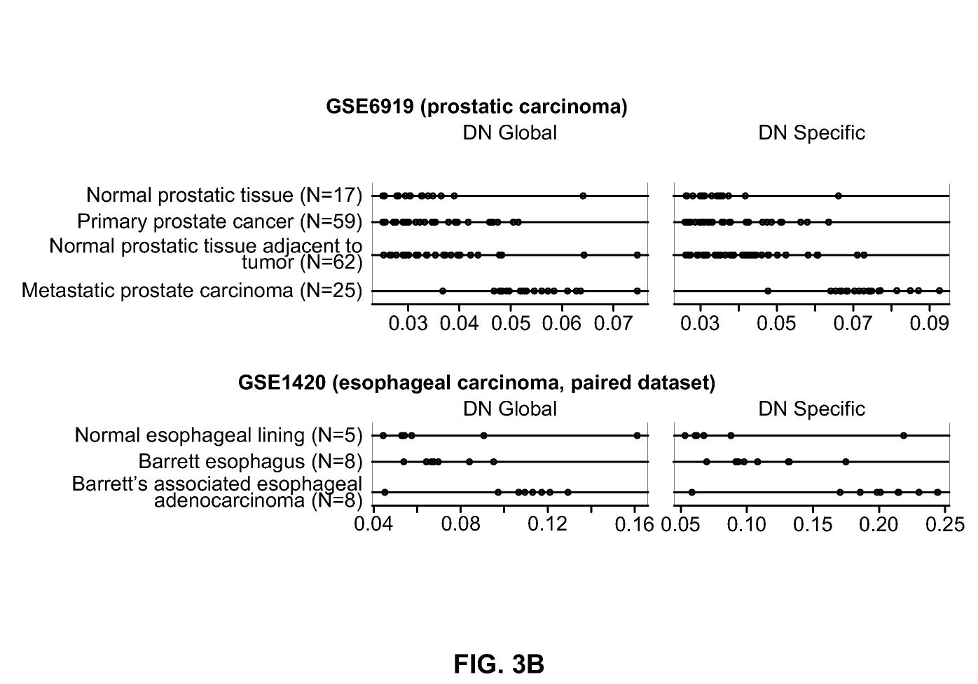

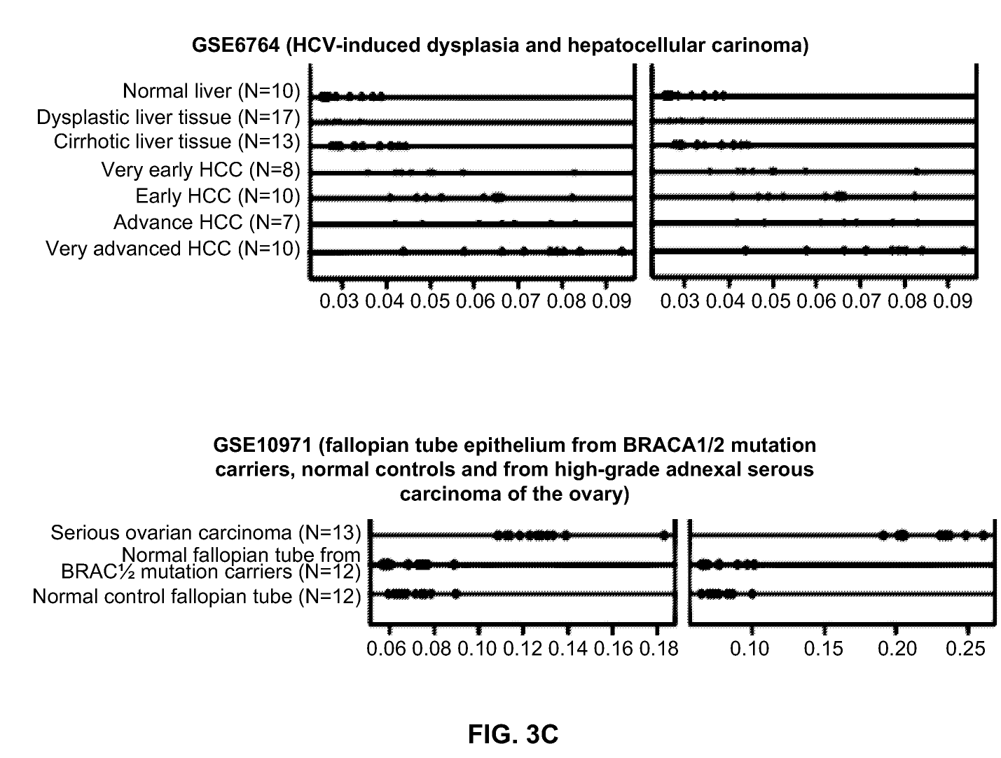

For each of these datasets linear graphs were generated. Each graph depicts the relative distance of every given sample to the Normal Sample Space as defined by DNGlobal and DNSpecific metrics (FIGS. 3A through 3C). As could be seen at the FIG. 1, both DNGlobal and DNSpecific place the most malignant tumors farther from the normal tissue control than the least malignant tumors or relatively benign tumors precursor states. The only case when metastatic tumors were less distant from the Normal Tissue Space than primary tumors, was the comparison of metastatic transitional cell carcinomas (TCC) of the bladder and superficial TCC with carcinoma in situ (TCC-CIS) (dataset GSE3167). This discrepancy might be explained by previous observations that the presence of concomitant CIS confers a worse prognosis in patients TCC. In the cases when easy visual discrimination of the tumor and normal/benign samples could be achieved, the performances of DNGlobal and DNSpecific were comparable. These results suggest that the genome-wide metrics may help to assess the ‘degree of malignancy’ of the tumor cells.

Example FIGS. 3A and 3B show linear graphs depicting the relative distance of every given sample to the Normal Sample Space as defined by DNGlobal and DNSpecific metrics in the multi-stage datasets.

Example FIG. 3B illustrates the linear graphs of the DN metric for the multi-stage datasets GSE6764 and GSE10971. Various stages in the progression are depicted in each of these datasets.

d) Principal Component Analysis (PCA) of the Distance Spaces

In addition to the direct correlation between indexes, the degree of the mutual correlation between DNGlobal and DNSpecific distances could be quantified by the principal component analysis (PCA) on the four dimensional space spanned by these four indexes (DCGlobal, DNGlobal, DCSpecific, DNSpecific). PCA gives an immediate quantitative appreciation of the relative importance of the architectural modes of gene regulation. Typical results of the PCA analysis of the two-point and multipoint (one for each type) datasets are reported in Table 8. The patterns of the component loading are remarkably consistent across all the 24 (including multi-stage) datasets analyzed. The proportion of the variation observed is also similar across the datasets. The variance data for the two-point data can be observed for paired and population datasets in Tables 9 and 10, respectively

In the four-dimensional space, the PCA generated four components reflecting the variation in the data. The first component (PC1) is the largest one. In this component all the indexes enter with the same direction of correlation (loading sign). This component might reflect the presence of the attractor. The proportion of the variance it explains reflects the relative importance of attractor (cell type) driven dynamics in gene expression regulation. As all the distance indexes are positively correlated along this axis and as the distance from this attractor is equally measured by all the distance indexes adopted (DNGlobal, DNSpecific, DCGlobal, DCSpecific), this attractor corresponds to the center of distribution, and the PC1 (distance from the attractor) has the same sign as measured by any of the indexes. PC1 component explains by far major portion of information contained in the expression profiles and, given the homogeneity of signs, it reflects a topological ‘distance from a centre’ (here, a center of attractor) from which all the samples could have either lesser or higher distance independently of being cancer or normal samples.

Example Table 8 illustrates the relative importance of components and the actual loadings corresponding to the distances in the two-point datasets GDS1165 and GSE12345. The pattern of loadings marked with *'s is consistent across all the datasets.

TABLE 8
Two-point dataset: Papillary thyroid carcinoma dataset (GDS1665)

| | | PC2 | | |
|---|---|---|---|---|
| | | “Normal/ | PC3 | |
| | PC1 | Cancer | “Degree of | PC4 |
| | “Attractor” | difference” | autonomy” | “Noise” |
| Relative | | | | |
| importance | | | | |
| Standard | 0.0968 | 0.0398 | 0.00375 | 0.00120 |
| deviation | | | | |
| Proportion of | 0.8542 | 0.1444 | 0.00128 | 0.00013 |
| Variance | | | | |
| explained by | | | | |
| component | | | | |
| Cumulative | 0.8542 | 0.9986 | 0.99987 | 1.00000 |
| Proportion | | | | |
| Component | | | | |
| Loadings: | | | | |
| DCGlobal | −0.4055784* | 0.1936700 | −0.4882024* | 0.7481019 |
| DNGlobal | −0.3365074* | −0.2185903* | −0.7043803* | −0.5855164* |
| DCSpecific | −0.6383106* | 0.6270132 | 0.3455199 | −0.2828959* |
| DNSpecific | −0.5610958* | −0.7221944* | 0.3822601 | 0.1322270 |

Multi-stage dataset: Mesothelioma (GSE12345)

| | | PC2 | | |
|---|---|---|---|---|
| | | (Normal/ | PC3 | |
| | PC1 | Cancer | (Degree of | PC4 |
| | (Attractor) | difference) | autonomy) | (Noise) |
| Relative | | | | |
| importance: | | | | |
| Standard | 0.244 | 0.0846 | 0.00892 | 0.00362 |
| deviation | | | | |
| Proportion of | 0.892 | 0.1071 | 0.00119 | 0.0002 |
| Variance | | | | |
| Cumulative | 0.892 | 0.9986 | 0.9998 | 1 |
| Proportion | | | | |
| Component | | | | |
| Loadings: | | | | |
| DCGlobal | −0.34642* | 0.145146 | −0.63865* | 0.671609* |
| DNGlobal | −0.34828* | −0.08457* | −0.59061* | −0.72299 |
| DCSpecific | −0.51471* | 0.780904 | 0.334231 | −0.11643 |
| DNSpecific | −0.70269* | −0.60164* | 0.362763 | 0.1125338 |

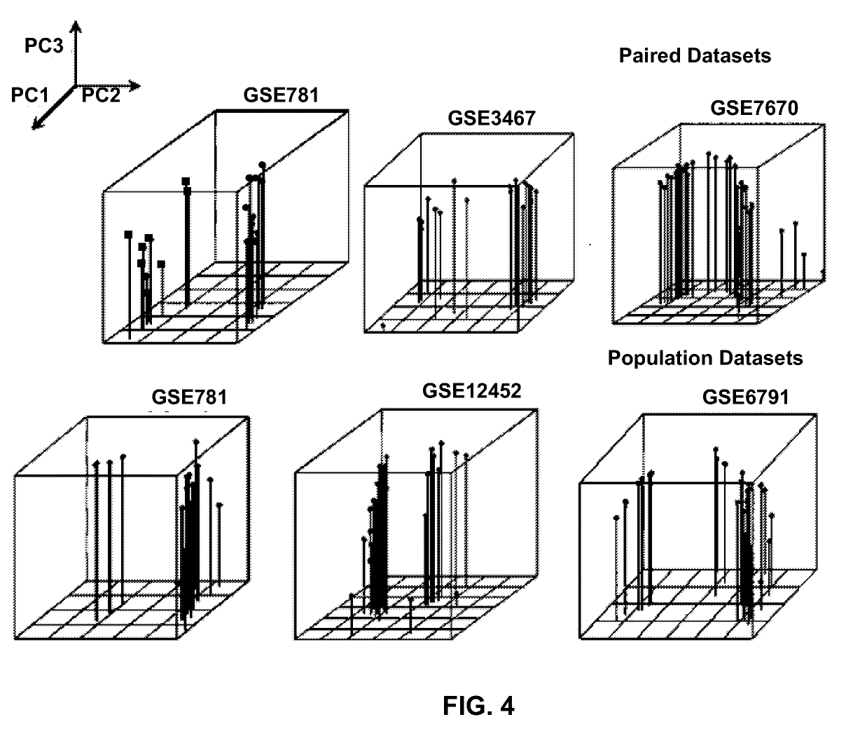

The second component (PC2) puts in opposition (opposite loading signs) the distances from cancer (DC) and normal (DN) poles. The topological structure described by PC2 corresponds to the fact that normal and cancer poles do in effect occupy distinct positions in the gene expression space and thus, as for this structure, there must be a component of the distances indexes reflecting the relatively higher (lower) distance of a sample from the Normal or Tumor pole (FIG. 4). The modulation driven by Tumor/Normal relative distance is less important than the cell-kind attractor, as is inferred from the observation that the portion of the variance explained by PC2 is considerably lower than the portion explained by PC1. Along this component, DNSpecific and DNGlobal indices enter with the same loading sign, while being in opposition to the DCSpecific and DCGlobal pair.

Example Table 9 illustrates PCA profiles of two-point paired datasets representing the proportion of variance observed by each component.

TABLE 9

| | | PC2 | PC3 |
|---|---|---|---|
| Proportion of Variance/ | PC1 | (Normal/Cancer | (Degree of |
| Dataset | (Attractor) | difference) | autonomy) |
| Ductal Breast Carcinoma | 0.908 | 0.0901 | 0.00107 |
| (GSE5764) | | | |
| Lobular Breast Carcinoma | 0.882 | 0.116 | 0.00199 |
| (GSE5764) | | | |
| Pulmonary adenocarcinoma | 0.8635 | 0.1361 | 0.00022 |
| (GSE2514) | | | |
| Pulmonary adenocarcinoma | 0.917 | 0.0815 | 0.00108 |
| (GSE7670) | | | |
| Renal cell carcinoma | 0.777 | 0.2231 | 0.00023 |
| (GSE6344) | | | |
| Renal cell carcinoma | 0.781 | 0.219 | 0.00055 |
| (GSE781) | | | |
| Head and neck squamous | 0.954 | 0.0436 | 0.00252 |
| cell carcinoma (GSE6631) | | | |
| Papillary thyroid | 0.8542 | 0.1444 | 0.00128 |
| carcinoma (GSE3467) | | | |
| Esophagus Carcinoma | 0.875 | 0.124 | 0.124 |
| (GSE1420) | | | |

The third component (PC3) reflects the ‘degree of autonomy’ of the signature genes from the global behavior of the cell-kind attractor. Relative strength of PC3 tells us whether signature genes possess intrinsic difference from the components of the general expression landscape or simply represent transcription units most sensitive to the common regulatory signal. Latter behavior is registered by PC2, while purely ‘democratic’ behavior of gene expression profile is registered by PC1. Intuitively, the loading pattern of PC3 component (the loadings correspond to the correlation coefficient of the original variables with the components) should have the specific (DNSpecific, DCSpecific) and global (DNGlobal, DNSpecific) indexes entering with opposite signs.

Example Table 10 illustrates PCA profiles of two-point population datasets representing the proportion of variance observed by each component.

TABLE 10

| | | PC2 | PC3 |
|---|---|---|---|
| Proportion of Variance/ | PC1 | (Normal/Cancer | (Degree of |
| Dataset | (Attractor) | difference) | autonomy) |
| Invasive Breast | 0.978 | 0.0192 | 0.00233 |
| (Epithelial) | | | |
| Carcinoma (GSE10797) | | | |
| Invasive Breast | 0.986 | 0.012 | 0.0013 |
| (Stromal) | | | |
| Carcinoma (GSE10797) | | | |
| Cervical Carcinoma | 0.884 | 0.1153 | 0.00029 |
| (GSE6791) | | | |
| Head and Neck | 0.967 | 0.0319 | 0.00072 |
| Carcinoma (GSE6791) | | | |
| Mesothelioma | 0.892 | 0.1071 | 0.00119 |
| (GSE12345) | | | |
| Nasopharyngeal | 0.934 | 0.0655 | 0.00062 |
| Carcinoma (GSE12452) | | | |
| Oral Squamous Cell | 0.914 | 0.0857 | 0.00059 |
| Carcinoma (GSE3524) | | | |
| Renal Cell carcinoma | 0.891 | 0.1027 | 0.00669 |
| (GSE14762) | | | |
| Papillary thyroid | 0.814 | 0.1847 | 0.00094 |
| carcinoma (GSE3678) | | | |

The proportion of the variation explained by fourth component (PC4) was negligible in all the cases compared to three previously discussed components. The PC4 might represent the ‘background’ noise generated by the stromovascular or other cells that may be present in the analyzed tissue samples. The PC4 would explain the smallest proportion of observed variation between sample sets. Its relatively small size reflects the strict quality controls used in the procedure of the selection of the published high-throughput datasets used in the current study.

FIG. 4 illustrates the three-dimensional representation of the principal components PC1, PC2 and PC3 in the two-point paired and population datasets. Normal samples are shown in blue and tumor samples are shown in red. This figure specifically highlights the classification power of PC2 (Normal/Cancer classifier) that does not require selection or validation of the minimized expression signature.

In analyzed datasets, the relative importance of cell-kind driven gene expression regulation (PC1) was ranged from 77% to 98%, while the distinction between normal and cancer poles (PC2) was ranged from 22% to 1%. The ‘degree of autonomy’ (signature genes working independently of global attractor dynamics) was represented by smallest component (PC3) being less than 1% in all datasets with an exception of esophageal dataset (GSE1420).

e) Cancer—an Attractor with Intermediate Regulatory Framework

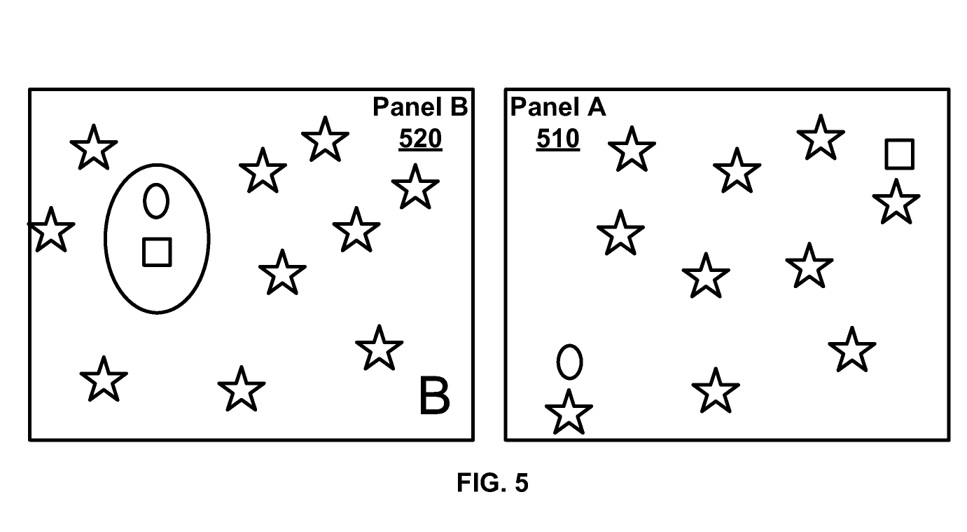

Results of the principal component analysis could be used to discern the topological structure of cancer and cell-kind attractors. Observations support the hypothesis of cancer being a stable attractor state in the dynamic system with intermediate regulation architecture could be described as a midpoint between “democratic” and “autocratic” regulatory landscapes. The intermediate paradigm is illustrated through an analysis of PC2 that is able to “readily sense” the difference between Normal and Cancer samples using both specific and global distance measures. Despite the fact that specific indices (gene signatures) enter as higher loadings on PC2 as compared to global distance indexes, latter indices also play a substantial role. In the case of purely ‘democratic’ architecture, PC3 would be expected to accounts for only a very small portion of variation; otherwise, at least some degree of autonomy of signature, or ‘master’, genes shall be acknowledged. Thus, after analysis of the principal components, it is concluded that the canalization of the tumor development towards the stabilization of the cell population in the cancer attractor state follows the intermediate paradigm [not fully “democratic” or not fully “autocratic”]. It is worth noting, that the use of the distances (instead of the differences in the expression levels for individual genes) allows for an unbiased estimation of the regulatory paradigm in the living system, as each descriptive parameter of the system (global, specific, normal, tumor) is described by numerical value and evaluated as such, being not affected by the number of genes that passed some arbitrary significance threshold chosen for individual dataset. The cancer attractor model arising from the results obtained in the present study is depicted in the FIG. 5.

FIG. 5 shows two panels: Panel A 510 describes the topology of the cell-kind and tumor attractors supported by present study; and Panel B 520 reports the classical view of cancer. The circle and square represent the cancer and normal attractor states as distinct poles. The rectangle represents the phase space of possible gene expression profiles, the stars are the observed samples, while the ellipse represents the general cell-kind attractor. From this model, one may derive that the cells that by one or another reason leave “stable state” and depart from the normal attractor may with relatively high probability be attracted to the road toward cancer attractor without the prerequisite of getting departed from relatively strong cell-kind attractor.

As could be seen from the FIG. 5, the topology of the cell-kind and tumor attractors supported by present study closely follows the Huang's hypothesis stating that the cancer is a sub-attractor of the general cell kind attractor. The main component defining the location of the sample in the space occupied by all samples is its distance from the general cell-kind attractor, thus the samples far removed from the normal sub-attractor are also distant from the cancer sub-attractor (PC1 component). In case of PC1, DN and DC indices are correlated and enter with the same sign into the component. The second component, PC2, discriminates if a given sample is closer to the cancer or normal sub-attractors (PC2 has opposite signs for DN and DC). Therefore, the similarity between cancer and normal samples is greater than the difference between them. In other words, prostatic cancer cell remains a prostate cell after all. Notable, this view is substantially different from the “classical” understanding of the tumorigenesis, when tumor and normal cells occupy the opposite poles of the allowed expression space (FIG. 5, Panel B). If the “classical” model was correct, PC1 should have DN and DC indices entering with opposite signs reflecting negative correlation values.

A case study performed on the breast carcinoma dataset (GSE10971) may serve as a good illustration for an attractor model. The multi-stage dataset comprises luteal phase fallopian tube epithelium from BRCA1/2 mutation carriers and from normal controls as well as the samples of the high-grade adnexal serous carcinoma of the ovary. Traditional analysis of this data collected using Affymetrix microarrays highlighted specific gene signature that passed multiple test correction places. This gene signature places fallopian tube epithelium from BRCA1/2 mutation carriers close to the high-grade serous carcinoma samples. Analysis of both Global and Specific distance charcteristics indicated that the normal epithelial samples collected from the patients predisposed to ovarian carcinoma have not yet embarked on the travel toward “cancer” attractor (FIG. 3C). Other three-point datasets also provided clear discrimination between normal and malignant states, while providing relatively poor discrimination for the true normal and pre-malignant samples (FIG. 3A). The only case when surefooted discrimination was possible at the earliest stages of the carcinogenesis was a set of samples representing the progression of the hepatocellular carcinoma (dataset GSE6764, FIG. 3C). All together, observations point that the shift toward cancer attractor either takes place relatively late in the process of carcinogenesis or requires some time to become substantial. This observation also goes well with the hypothesis that cancer-specific changes of the expression landscape are subject to intermediate regulatory pattern, representing the middle ground between “democratic” and “autocratic” regulatory landscapes.

### SUMMARY

Here we presented quantitatively evidence supporting the structure of the cancer attractor and the hypothesis that cancer-specific changes of the expression landscape are subject to intermediate regulatory pattern, representing the middle ground between “democratic” and “autocratic” regulatory landscapes. The remarkable similarity of the observations made using multiple independent datasets, including these comprised of multiple types of samples demonstrates robustness of the genome-wide expression signatures as a mean to diagnose tumors. This study supports the view of the cell population as dynamic system. Moreover, the strong correlation between the ‘distance from normal’ and ‘distance from cancer’ poles for all the analyzed samples proves existence of a cell-kind-attractor, with cancer and normal poles representing two sub-attractors.

There are a number of immediate applications of the analyses performed. First, after initial sets of normal and tumors samples for each particular cancer are analyzed to define Normal and Cancer Spaces, the classification of any new sample to be diagnosed could be achieved by calculation sample specific distance from this sample to Normal Space (DN) and Cancer Sample (DC). If DN>DC sample will be classified as cancer, If DC>DN, sample will be classified as normal. An increase in the number of the initially profiled samples with provide for better definition of the Normal and Cancer Spaces and better classification of the subsequent samples. Second, for every sample to be diagnosed, the distance from the sample to the Normal Space could be plotted linearly, and the degree of the malignancy of the given sample will be proportional to the linear distance. Relative degree of the malignancy could be assigned to the sample using whole-genome patterns of the gene expression, without the need for specific biomarkers or gene signatures. Third, the principal component analysis (PCA) on the four dimensional space spanned by four indexes (DCGlobal, DNGlobal, DCSpecific, DNSpecific) could be used for diagnostic discrimination of the sampels. Each new sample to be diagnosed should be added to initial (reference) dataset of the cancer and normal tissues of the particular cell-type, PCA executed at whole dataset, then first three components (PC1, PC2, PC3) should be used for three dimensional graphing of the results. New samples will be co-classified with the group of the samples with similar degree of the malignancy.

Cell populations are collective dynamic systems living in a phase space where only very specific low energy states (cell kind attractors) are compatible with survival. These attractor states define cell differentiation. When cell departs from its cell-kind attractor, there are only three possible scenarios. One, cell could die as a result of a profound deregulation of its molecular networks incompatible with survival. Second, cell could be attracted back to the normal pole of the cell-kind attractor. Third, cell could randomly fall under the influence of the cancer pole of the cell-kind attractor, and acquire tumorigenic properties. The ‘cell kind’ barriers are energetically much higher than the normal/cancer one, thus, offering a possibility of the ‘global reversion’ of cancer phenotype. It might be possible to find the way to “kick” the cell out of equilibrium, and, therefore, out of the influence of cancer pole of cell-kind attractor. Being removed from low energy state, cell may be pushed to face three possible fates again: death, normalization or attracting back to the cancer pole. Of course, the molecular or other mean of the ‘global reversion’ therapy should be delivered specifically to the cancer cells. ‘Global reversion’ therapy cannot be based on the exploitation of ‘master key genes’, but should rely on more general means, for example, previously postulated morphogenetic fields sharing some similarities in embryonic and cancer cells.

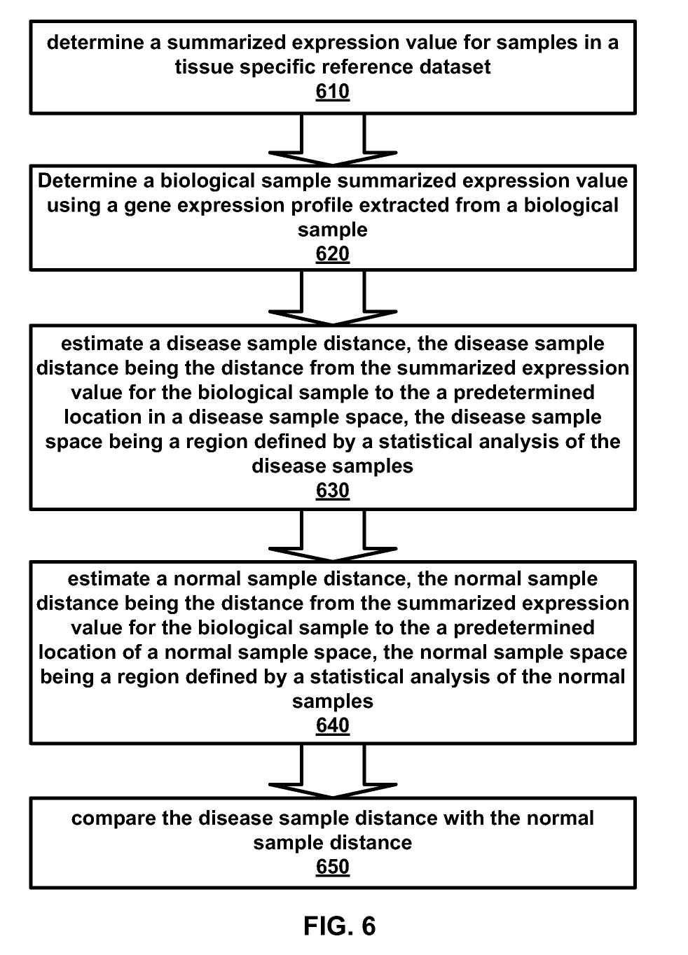

FIG. 6 is a flow diagram of a method to determine if a biological sample is diseaseous as per an aspect of an embodiment of the present invention. Additionally, other embodiments of the present invention may be substantiated as a non-transient computer readable medium that contains computer readable instructions that when executed by one or more processors, causes said “one or more processors” to perform a method to determine if a biological sample is diseaseous.

According to embodiments, a summarized expression value for each of a multitude of samples in a tissue specific reference dataset may be determined. At 610. The summarized expression value being a summation of a multitude of gene expression levels. The multitude of samples should include both disease samples and normal samples. In embodiments, the disease samples and the normal samples may be paired. The multitude of samples may include multiple samples from an individual or multiple samples from across a larger group of individuals. The summarized expression value may be determined using a mathematical operation that generates a complex metric encompassing gene expression values for each of the multitude of samples.

Biological samples may be obtained in numerous well-known ways such as a biopsy. The disease samples may be cancer samples or other diseased samples. Samples may be labeled when their disease state is known. The labels can include any number of identifiers such as: a diseased sample, a cancer sample, a precancerous sample, a metastatic sample, and/or a normal sample. Examples of disease samples include, but are not limited to: Bladder carcinoma; Pancreatic cancer; Prostatic carcinoma; Esophageal carcinoma; HCV-induced dysplasia; Hepatocellular carcinoma; and/or Ovarian carcinoma.

A biological sample summarized expression value may be determined at 520 using a gene expression profile extracted from a biological sample. The gene expression profile for the biological sample may be determined using microarray data or other gene determining mechanisms known in the art, for example, sequencing data. In embodiments, the gene expression profile may be added the to the reference dataset once it is classified to increase the number of samples in the reference dataset. The gene expression profile may be operated on to improve the data. Examples of such operations include background corrections or normalization. Additionally, identified outliers may be removed or ignored.

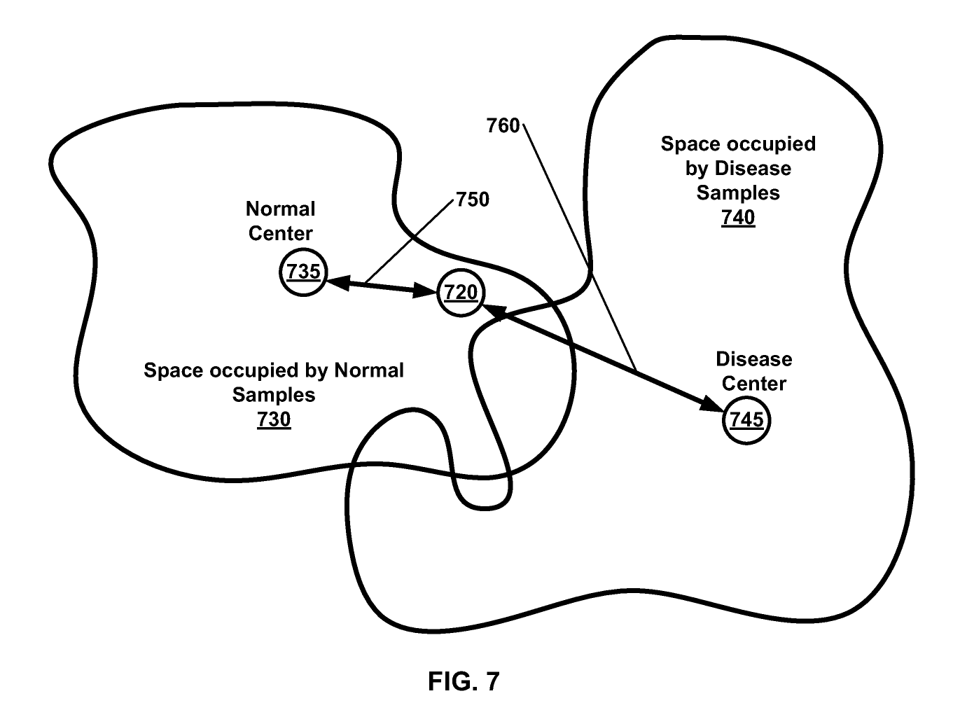

FIG. 7 shows the relations ship of distances between the biological sample and normal and disease spaces. A disease sample distance 760 may be estimated at 630. The disease sample distance 760 being the distance from the biological sample summarized expression value 720 to a predetermined location in a disease sample space 745. The disease sample space 740 being a region defined by a statistical analysis of the disease samples. The predetermined location 745 may be the center of the disease sample space 740. Alternatively, the predetermined location 745 may be at some other statistically significant location. A disease sample distance 760 may be estimated using many numerical techniques including using a Pearson correlation coefficient.

A normal sample distance 750 may be estimated at 640. The normal sample distance 750 being the distance from the biological sample summarized expression value 720 to a predetermined location 735 in the normal sample space 730. The normal sample space 730 is a region defined by a statistical analysis of the normal samples. The predetermined location 735 may be the center of the normal sample space 730. Alternatively, the predetermined location 735 may be at some other statistically significant location. A normal sample distance 750 may be estimated using many numerical techniques including using a Pearson correlation coefficient.

The disease sample distance 760 is compared with the normal sample distance 750 at 650. The comparing may occur in numerous ways including a simple comparison or through a more complex statistical analysis. For example, the biological sample may be declared as being diseased if the disease sample distance 760 is less than the normal sample distance 750 by a predetermined statistical margin. In alternative embodiments, the comparison may be performed in such a way as to determining a severity of malignancy for the biological sample. To determine the severity of a malignancy for the biological sample, one could make a calculation that includes taking the ratio of the disease sample distance 760 and the normal sample distance 750, or some variant thereof.

Principal Component Analysis (PCA) may also be performed on the reference dataset to obtain disease state information as described earlier.

In this specification, “a” and “an” and similar phrases are to be interpreted as “at least one” and “one or more.” References to “an” embodiment in this disclosure are not necessarily to the same embodiment, and they mean at least one embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A non-transient computer readable medium that contains computer readable instructions that when executed by one or more processors, causes said “one or more processors” to perform a method to determine if a biological sample is diseaseous, the method comprising:
a. determining a summarized expression value for each of a multitude of samples in a tissue specific reference dataset, the summarized expression value being a summation of a multitude of gene expression levels, the multitude of samples including:
i. disease samples; and
ii. normal samples;
b. determining a biological sample summarized expression value using a gene expression profile extracted from a biological sample;
c. estimating a disease sample distance, the disease sample distance being the distance from the biological sample summarized expression value to a predetermined location in a disease sample space, the disease sample space being a region defined by a statistical analysis of the disease samples;
d. estimating a normal sample distance, the normal sample distance being the distance from the biological sample summarized expression value to a predetermined location of a normal sample space, the normal sample space being a region defined by a statistical analysis of the normal samples; and
e. comparing the disease sample distance with the normal sample distance.

2. The medium according to claim 1, wherein determining a summarized expression value includes using a mathematical operation that generates a complex metric encompassing gene expression values for each od the multitude of samples.

3. The medium according to claim 1, wherein the disease samples are cancer samples.

4. The medium according to claim 1, wherein the predetermined location is the center.

5. The medium according to claim 1, further including declaring the biological sample diseased if the disease sample distance is less than the normal sample distance by a predetermined statistical margin.

6. The medium according to claim 1, further including determining a severity of malignancy for the biological sample using the disease sample distance and the normal sample distance.

7. The medium according to claim 1, further including determining a severity of malignancy for the biological sample using the ratio of the disease sample distance and the normal sample distance.

8. The medium according to claim 1, wherein the disease samples and the normal samples are paired.

9. The medium according to claim 1, further including adding the gene expression profile to the reference dataset.

10. The medium according to claim 1, wherein the developing a gene expression profile for the biological sample uses microarray data.

11. The medium according to claim 1, wherein the developing a gene expression profile for the biological sample uses sequencing data.

12. The medium according to claim 1, wherein the gene expression profile is background corrected.

13. The medium according to claim 1, wherein the multitude of samples includes at least two samples from an individual.

14. The medium according to claim 1, wherein the multitude of samples includes samples across a multitude of individuals.

15. The medium according to claim 1, wherein the biological sample is a biopsy.

16. The medium according to claim 1, wherein at least one of the multitude of samples is labeled.

17. The medium according to claim 1, wherein at least one of the multitude of samples is labeled as at least one of the following:
a. a diseased sample;
b. a cancer sample,
c. a precancerous sample;
d. a metastatic sample; and
e. a normal sample.

18. The medium according to claim 1, wherein a Pearson correlation coefficient is used to estimate a distance for at least one of the following:
a. the disease sample distance; and
b. the normal sample distance.

19. The medium according to claim 1, further including performing a Principal Component Analysis (PCA) on the reference dataset.

20. The medium according to claim 1, wherein at least one of the disease samples is at least one of the following:
a. Bladder carcinoma;
b. Pancreatic cancer;
c. Prostatic carcinoma;
d. Esophageal carcinoma;
e. HCV-induced dysplasia;
f. Hepatocellular carcinoma; and
g. Ovarian carcinoma.
